(19) United States
(12) Patent Application Publication
(10) Pub. No.: US 2005/0018054 A1
(43) Pub. Date: Jan. 27, 2005

(54) Chroma compensation circuit and its method

(76) Inventor: Akihiro Kato, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/895,842

(22) Filed: Jul. 22, 2004

(30) Foreign Application Priority Data
Jul. 22, 2003 (JP) 2003-199861

(51) Int. Cl. H04N 5/228

(52) U.S. Cl. 348/222.1

(57) ABSTRACT

In this invention, a chroma compensation circuit includes: a hue detector for employing input R, G and B color signals to determine which hue areas to which the R, G and B color signals belong; a compensation signal generator for employing the output of the hue detector to generate hue compensation signals; and a compensation addition unit for performing a matrix operation for the input R, G and B color signals to generate color difference signals, for performing chroma compensation for the color difference signals by employing the hue compensation signals generated by the compensation signal generator, and for performing an inverse matrix operation for the color difference signals obtained by the chroma compensation and outputting R, G and B color signals.

### BACKGROUND OF THE INVENTION

1. Field of the Invention

The present invention relates to a chroma compensation circuit for a color television camera, and in particular to a chroma compensation circuit that can independently adjust saturation and hue for an arbitrary primary color component and a complementary color component.

2. Related Background Art

Since differences exist between colors as reproduced for a picture obtained by a color television camera and the colors as actually perceived by the eyes of a person, a color compensation operation must be performed. This also applies to a process for adjusting colors obtained by a plurality of cameras.

As to the methods available for performing color compensation operations, there are a linear matrix method, for, in principle, compensating for a color mixture by using a color separation prism, and a chroma compensation method, for enabling the independent alteration of six colors, red, green, blue, cyan, magenta and yellow.

According to the second method, i.e., the chroma compensation method, saturation and hue can be separately designated, so that color adjustments are easily performed. But while this is a great advantage, the configuration of the circuit employed is more complicated than is that required for the first method, i.e., the linear matrix method.

However, since for the processing of video signals obtained by a television camera digitization and integration have been improved, a complicated circuit configuration does not constitute a large problem, and as a result, the chroma compensation method is frequently employed.

In a television camera scanning two-dimensional image, even though imaging no matter how colorful object of shooting, however, the color processed in an instant moment (time cross section) is only each one of original and complementary color. For example, in the order of ratio of inputted R, G and B signal, in the case of G, R and B, it can be considered as a mixture of original color (G), complementary color (Ye) and white (achromatic color). Therefore, chroma compensation is to be calculated for original and complementary color.

According to the chroma compensation method, while white balance is maintained, i.e., while non-saturation is maintained by a non-saturation signal, color compensation is performed independently and variably for six colors, red, green, blue, cyan, magenta and yellow. While referring to FIG. 7, an explanation will be given for an example circuit configuration according to a conventional technique, disclosed in JP-A-9-247701, that provides the chroma compensation method. The conventional technique roughly comprises a hue detector 15, a compensation signal generator 16 and a compensation signal addition unit 17.

The hue detector 15 includes subtractors 1a to 1c and a hue area determination unit 2; the compensation signal generator 16 includes a vector value calculation unit 3, a constant selector 4 and multipliers 5a and 5b; and the compensation signal addition unit 17 includes sign inverters 6a and 6b, a data selection and addition unit 7 and adders 8a to 8c.

The hue detector 15 will now be explained. R (red), G (green) and B (blue) signals, supplied by the pickup device of a camera (not shown), are received by the subtractors 1a to 1c, which calculate subtraction signals (R-G), (R-B) and (G-B).

In order to determine hue areas 1 to 6 shown in FIG. 2, the hue area determination unit 2 examines the magnitudes of the signal levels by determining whether the subtraction signals (R-G), (R-B) and (G-B), which are the calculation results obtained by the subtractors 1a to 1c, are positive or negative. Then, the hue area determination unit 2 further determines to which of the six hue areas, R, G, B, Cy (cyan), Mg (magenta) and Ye (yellow), each of the signals belongs. The correlation between the relationship of the levels of the R, G and B signals and the hue areas is shown in FIG. 8.

As will be described later, the vector value calculation unit 3 employs a difference between the calculation results of the subtractors 1a to 1c to obtain vector values for the primary color components (R, G and B) and the complementary color components (Cy, Mg and Ye).

The compensation signal generator 16 will now be described. Based on the results obtained by the hue area determination unit 2 and in accordance with each constant of the saturation and hue predeterminedly stored to obtain a desired saturation and hue concerned with a predetermined color, the constant selector 4 selects constants used for compensation coefficients. Khr, Khg, Khb, Khc, Khm and Khy, which will be described later, for the individual hues R, G, B, Cy, Mg and Ye.

The multipliers 5a and 5b multiply the selected constants by the vector values for the hues R, G, B, Cy, Mg and Ye, obtained by the vector value calculation unit 3, and output compensation signals. At this time, only one primary color multiplier 5a and one complementary color multiplier 5b are employed.

Finally, the compensation signal addition unit 17 will be described. In accordance with the hue areas, the compensation signals output by the multipliers 5a and 5b are passed through the sign inverters 6a and 6b. Then, based on the determination results obtained by the hue area determination unit 2, the data selection and addition unit 7 selects one of the compensation signals to be output for the original R, G and B signals. Thereafter, the selected signal is added to the original R, G, B signals by the adders 8a to 8c, to generate R″, G″, B″, completing the chroma compensation.

Chroma compensation is carried out by dividing into six hue areas so as to obtain a desired saturation and hue concerned with a predetermined hue.

The compensation operation method employed for the saturation and hue for each six hue areas are well known as shown in FIG. 9. In FIG. 9, Ksr, Ksg, Ksb, Ksc, Ksm and Ksy represent saturation compensation coefficients used for respectively performing chroma compensation for red, green, blue, cyan, magenta and yellow, while Khr, Khg, Khb, Khc, Khm and Khy represent hue compensation coefficients used for respectively performing chroma compensation for red, green, blue, cyan, magenta and yellow.

The conventional technique does not take into consideration the affect on a luminance signal of the addition of the color compensation signal to the R, G and B signals. Since a luminance signal Y is Y=0.299×R+0.587×G+0.114×B, the luminance signal Y is changed when the color signal (red, green, blue, cyan, magenta or yellow) is corrected. Therefore, performing compensation for a color signal independent of a luminance signal is a problem.

According to the conventional technique, when the color signal is compensated for, accordingly, the level of the luminance signal is changed. The simulation results obtained in this case are shown in FIGS. 10 and 11. FIG. 10 is a graph obtained by plotting a color signal change on a color difference plane, while FIG. 11 is a graph in which the horizontal axis represents hue and the vertical axis represents a luminance signal change ratio.

The regular circle as shown in FIG. 10 indicates a state where a color signal called rainbow pattern signal of which saturation is 100% constant and of which hue is varied from “0” to “360” degree in continuous is inputted. “0” degree of hue means “0”% at R-Y, and B-Y is in the direction of positive value.

In FIG. 10, as an input signal, a rainbow pattern is employed wherein the saturation of the color signal is steady, i.e., 100%, and from 0 to 360 degrees, only the hue is continuously changed, describing a true circle, as shown. At this time, 0 degrees along the hue axis represents a hue for which B-Y is 100% and R-Y is 0.

As is apparent from FIG. 11, which corresponds to FIG. 10, according to the conventional technique the luminance is also changed as the color compensation is performed. Therefore, unique color compensation can not be provided and correct color compensation can not be performed. For example, when the saturation of the R signal is corrected to obtain a saturation 1.5 times the original (see FIG. 10), the luminance signal is also increased about 10%, as is shown in FIG. 11. As a result, independent color compensation can not be performed.

### SUMMARY OF THE INVENTION

It is one objective of the present invention to provide a chroma compensation circuit that can perform compensation for a color signal without causing a luminance signal to be changed.

To achieve this objective of the present invention, in a chroma compensation circuit that can independently adjust saturation and hue for the primary color component and the complementary color component of a television signal, R, G and B color signals are employed for determining a hue area and generating a color compensation signal, and a color compensation signal is added to color difference signals obtained by a matrix conversion of the R, G and B color signals.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the configuration of a chroma compensation circuit according to one embodiment of the present invention;

FIG. 2 is a saturation compensation vector diagram for the embodiment of the present invention;

FIG. 3 is a hue compensation vector diagram for the embodiment of the present invention;

FIG. 4 is a diagram for explaining a saturation and hue compensation operation method according to the embodiment of the invention;

FIG. 5 is a characteristic diagram obtained by compensating for the saturation of an R signal according to the embodiment of the invention;

FIG. 6 is a characteristic diagram obtained by optimizing saturation and hue compensation coefficients according to the embodiment of the invention;

FIG. 7 is a block diagram showing the configuration of an example conventional chroma compensation circuit;

FIG. 8 is a diagram for explaining an example hue area determination method for the chroma compensation circuit;

FIG. 9 is a diagram for explaining a conventional saturation and hue compensation operation method;

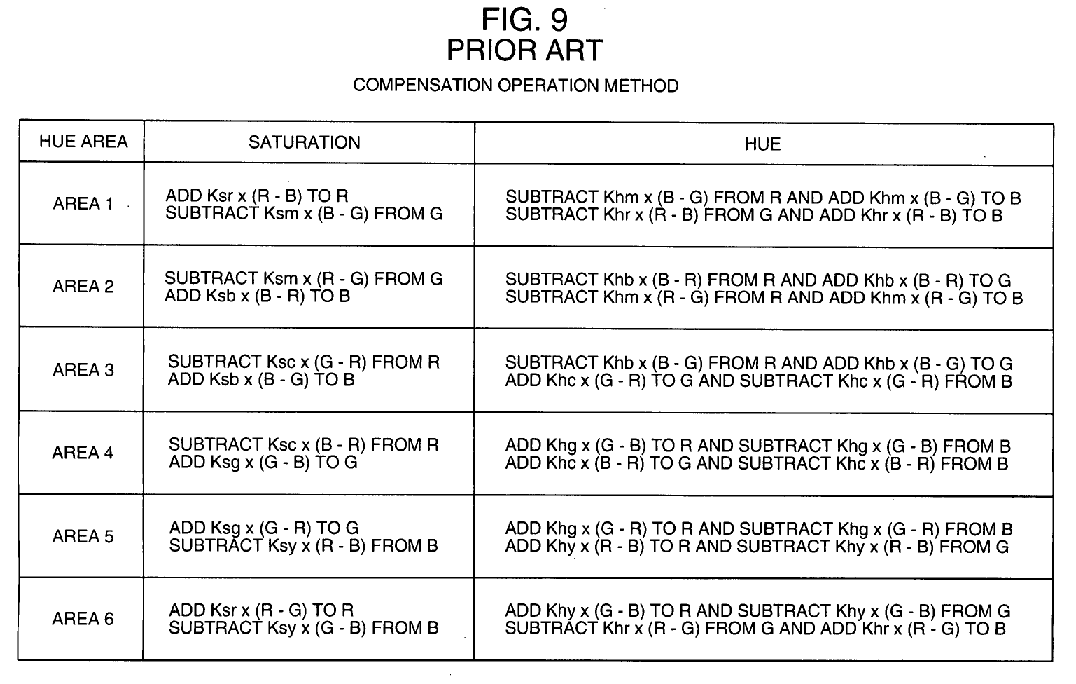

FIG. 10 is a characteristic diagram showing a change in a color signal according to the conventional technique; and

FIG. 11 is a characteristic graph showing a luminance signal change ratio according to the conventional technique.

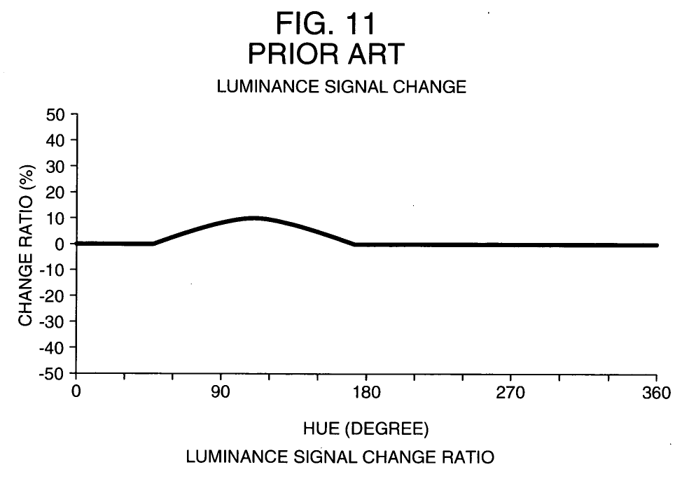

### DETAILED DESCRIPTION OF THE EMBODIMENT

The present invention provides a chroma compensation operation, based only on the conversion of a color signal, that leaves a luminance signal unchanged. As will be specifically described later while referring to one embodiment, R, G and B signals are employed to detect hue and to generate a color compensation signal, while the color compensation signal is to be added to the color difference signals, instead of to the original R, G and B signals.

For this process, a color difference signal and a luminance signal are completely independent of each other, and as is well known, to obtain the color difference signals and the luminance signal, the matrix conversion need only be preformed for the individual R, G and B signals. The conversion from the R, G and B signals to a luminance signal Y is performed based on the following equation (1), and the conversion from the R, G and B signals to color difference signals B-Y and R-Y is respectively performed based on the following equations (2) and (3).
Y=0.587×G+0.114×B+0.299×R (1)
B−Y=−0.587×G+0.886×B−0.299×R (2)
R−Y=−0.587×G−0.114×B+0.701×R (3)

In order to obtain R, G and B signals based on the luminance signal and the color difference signals, an inverse conversion need only be performed in accordance with the following equations (4), (5) and (6).
R=Y+(R−Y) (4)
G=Y−0.194×(B−Y)−0.509×(R−Y) (5)
B=Y+(B−Y) (6)

A chroma compensation circuit according to one embodiment of the present invention will now be described in detail while referring to the accompanying drawings.

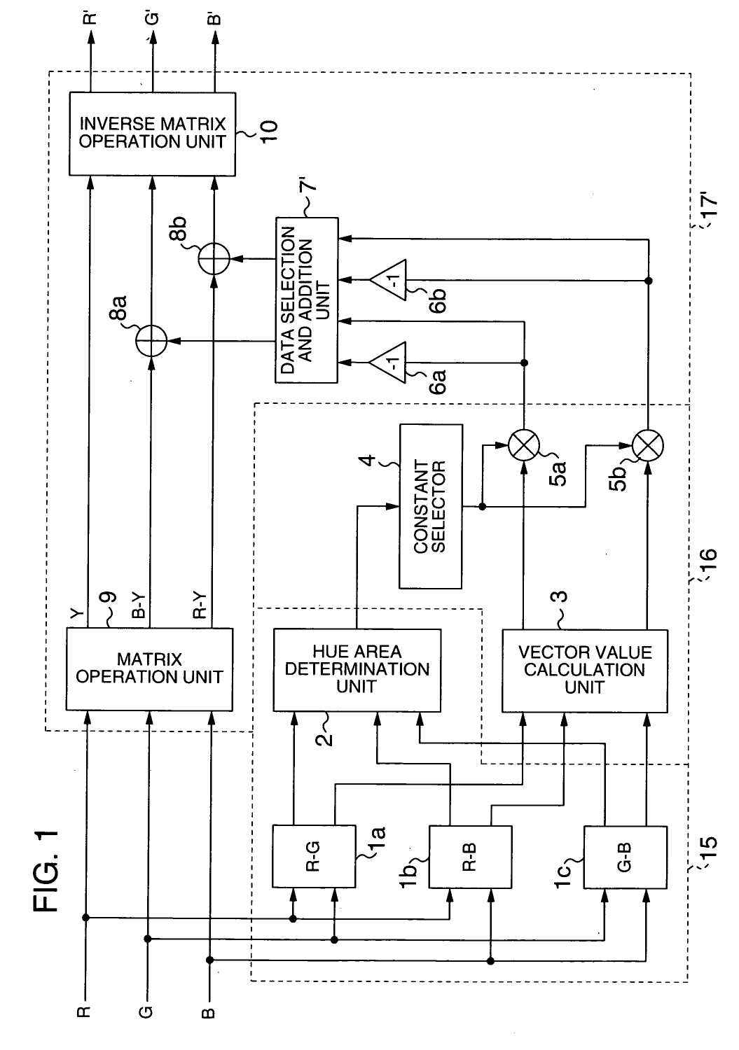

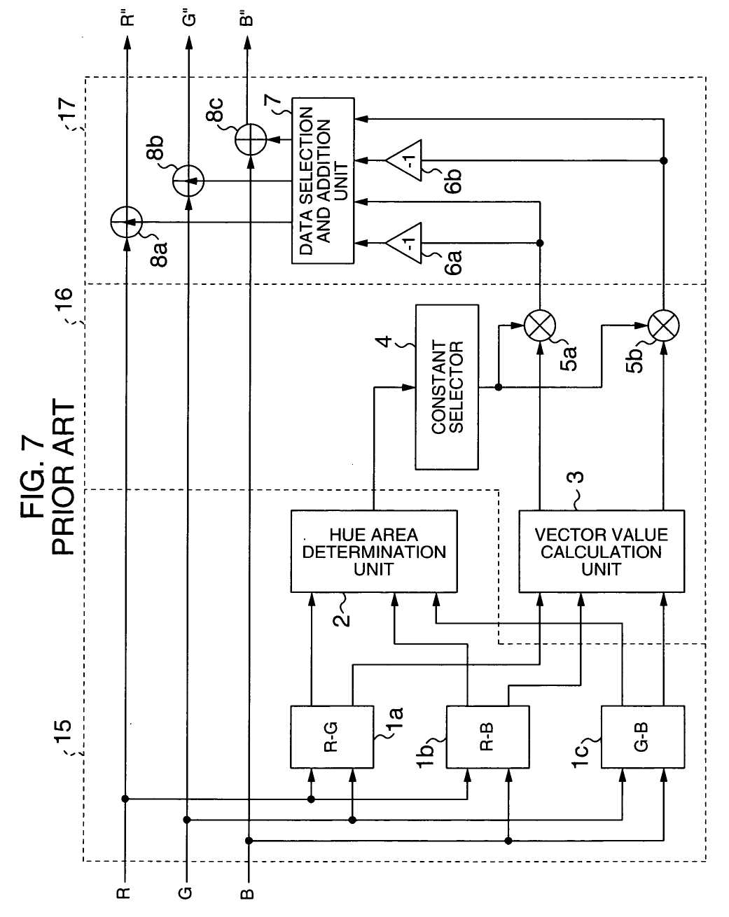

Referring to FIG. 1, the chroma compensation circuit for the embodiment, as well as the conventional chroma compensation circuit shown in FIG. 7, roughly comprises a hue detector 15, a compensation signal generator 16 and a compensation signal addition unit 17′. Further, as well as the conventional configuration, the hue detector 15 includes subtractors 1a to 1c and a hue area determination unit 2, and the compensation signal generator 16 includes a vector value calculation unit 3, a constant selector 4 and multipliers 5a and 5b.

In the embodiment shown in FIG. 1, the compensation signal addition unit 17′ includes sign inverters 6a and 6b, a data selection and addition unit 11, adders 8a and 8b, a matrix operation unit 9, and an inverse matrix operation unit 10.

Since the hue detector 15, which includes the subtractors 1a to 1c and the hue area determination unit 2, and the compensation signal generator 16, which includes the vector value calculation unit 3, the constant selector 4 and the multipliers 5a and 5b, are the same as those for the conventional technique shown in FIG. 7, no further explanation for these components will be given, and only the compensation signal addition unit 17′, which is the feature of the embodiment, will be explained.

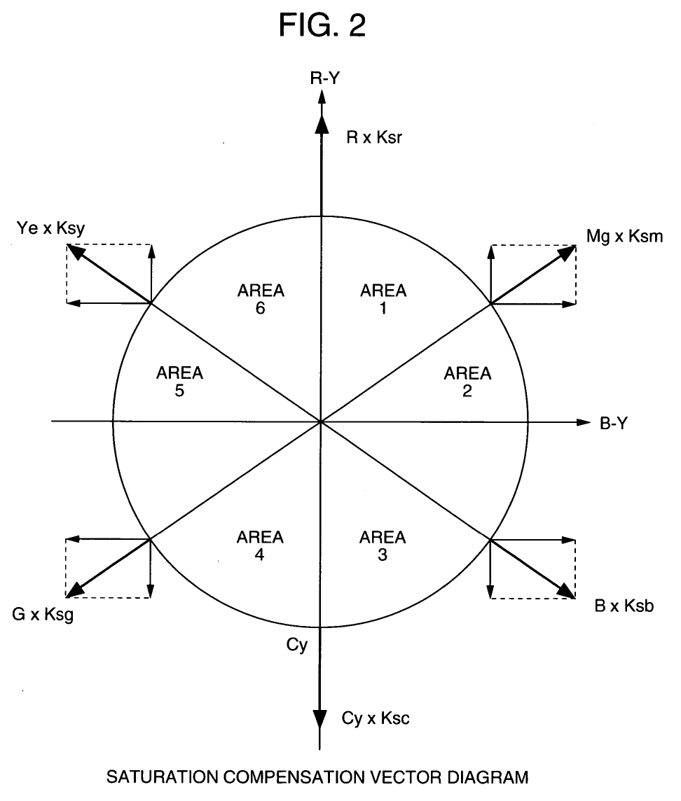

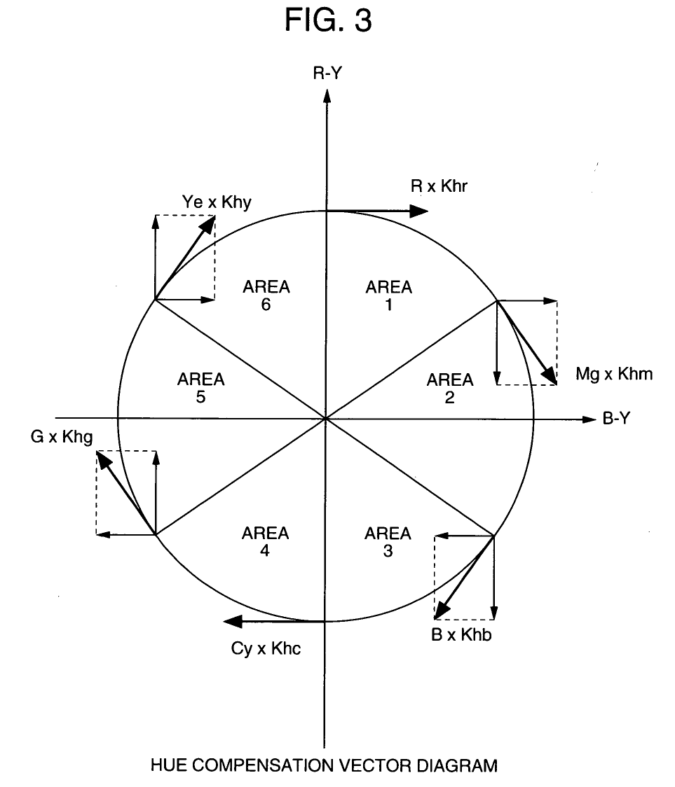

First, the method employed by the data selection and addition unit 11 for adding a color compensation signal will be described. FIG. 2 is a diagram showing saturation compensation vectors for six colors on a color difference plane, and FIG. 3 is a diagram showing hue compensation vectors for six colors on a color difference plane.

The data selection and addition unit 11 multiplies the compensation coefficients for the individual hues (saturations: Ksr, Ksg, Ksb, Ksc, Ksm and Ksy, and hues: Khr, Khg, Khb, Khc, Khm and Khy) by unit vectors representing the saturations (the radial directions of a circle) of the individual hues shown in FIG. 2 and by unit vectors representing the hues (the clockwise tangential directions of the circle) shown in FIG. 3. The obtained vectors are defined as compensation vectors, and signals obtained by separating these vectors in the B-Y axial direction and the R-Y axial direction are defined as compensation signals.

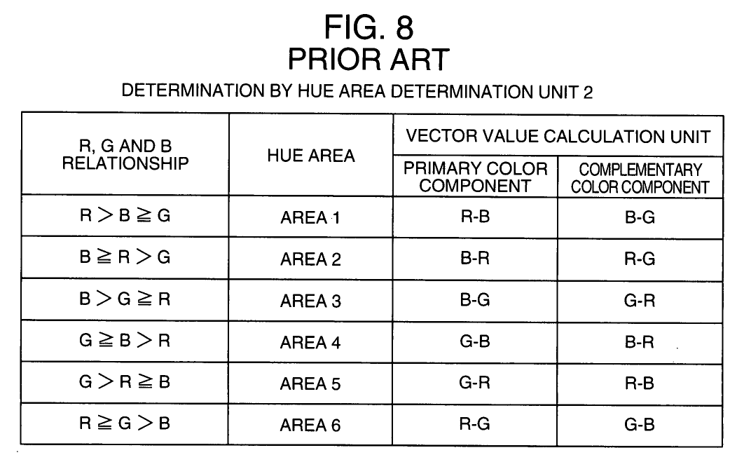

When the direction of the compensation signal corresponds to that of the B-Y axis or the R-Y axis, a positive sign is provided for the compensation signal, and when the direction of the compensation signal is the opposite of that of the B-Y axis or the R-Y axis, a negative sign is provided. Therefore, at this time, the compensation operation method for the saturation and the hue in each hue area is in judging hue areas as shown in FIG. 8 in accordance with large and small relation among inputted R, G, B to carry out compensation calculation.

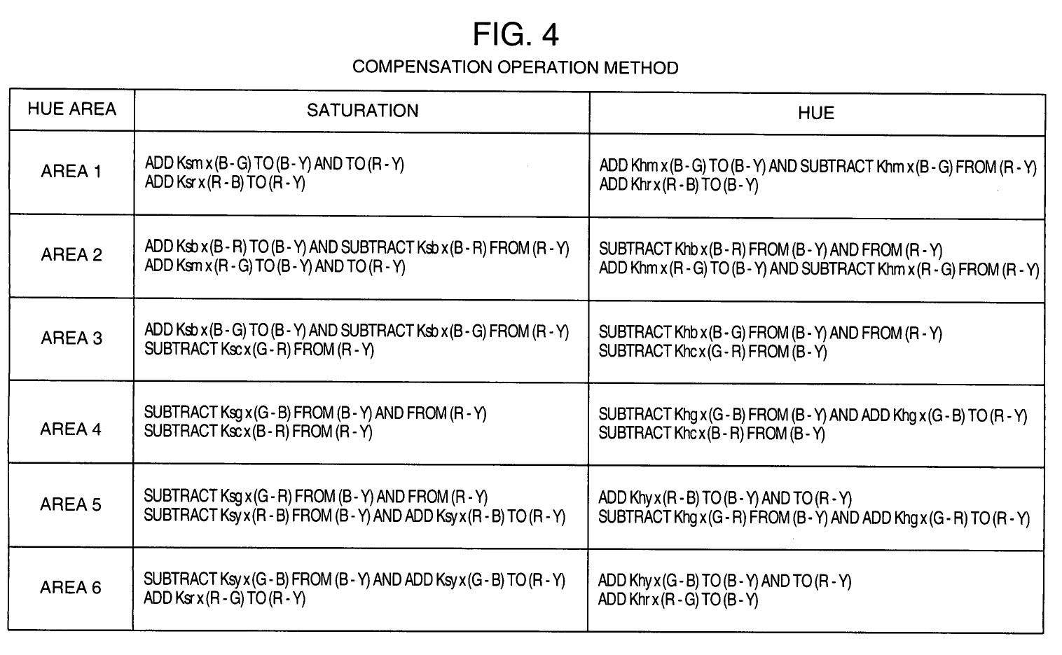

FIG. 4 discloses a compensation calculation method which is a one embodiments of this invention. As an example, an operation in which R, G and B signal of hue area 1 is inputted is explained. In the saturation calculation, since compensation coefficient of original color is Ksr, therefore, the calculation formula becomes (R-Y)+KSr×(R-B). In the saturation calculation, since compensation coefficient of complementary color is Ksm, therefore, the calculation formula becomes (R-Y)+Ksm×(B-G), and (B-Y)+Ksm×(B-G). In the hue calculation, since compensation coefficient of original color is Khr, therefore, the calculation formula becomes (B-Y)+Khr×(R-B). In the saturation calculation, since compensation coefficient is Khm, therefore, the calculation formula becomes (R-Y)−Khm×(B-G) and (B-Y)+Khm×(B-G). While, as to compensation coefficient of Ksr, Ksg, Ksb, Ksc, Ksm, Ksy, Khr, Khg, Khb, Khc, Khm and Khy, coefficient table or calculation formula is stored in constant selector 4 in beforehand so as to be in a desired saturation and hue concerned with a predetermined color.

The matrix operation unit 9 performs an arithmetic operation using equations (1) to (3) for the received R, G and B signals, and separates these signals into the luminance signal Y and the color difference signals B-Y and R-Y.

Of these signals obtained by the matrix operation unit 9, the luminance signal Y is transmitted unchanged to the inverse matrix operation unit 10, and the color difference signals B-Y and R-Y are added to the compensation signals by the adders 8a and 8b. The resultant signals are then transmitted to the inverse matrix operation unit 10. With this arrangement, chroma compensation is performed only for the color difference signals B-Y and R-Y.

The inverse matrix operation unit 10 performs an arithmetic operation using the equations (4) to (6) for the luminance signal Y and the color difference signals B-Y and R-Y that have been received. Through this processing, the input signals are changed to the original signal format, which are then output as R′, G′, B′ by the inverse matrix operation unit 10.

As a result, according to the embodiment, the color compensation operation is performed only for the color difference signals. Therefore, since the compensation process, according to this embodiment, need only be performed for color difference compensations B-Y and R-Y and not for the luminance signal Y, the luminance signal Y is not changed even by generating the luminance signal Y based on R′, G′, B′ output signal from inverse matrix operation unit 10. That is, chroma compensation can be performed without the luminance signal being changed.

This operation is performed because of a reduction in the circuit size; however, according to the method employed for this embodiment, compared with the conventional method for the addition of the compensation signals to the R, G and B signals, a slight shift is caused between the compensation performed for the saturation and the compensation performed for the hue.

Since, based on the R, G and B signals, the hue is detected in the same manner as in the conventional example, in order to obtain compatibility with the chroma compensation circuit of the camera in the conventional example, only a distortion compensation parameter for a compensation coefficient predesignated by a user need again be calculated using software, and the obtained numerical value need only be designated as a new compensation coefficient for the chroma compensation circuit. Substantially, the same results can be acquired as are obtained by the conventional method.

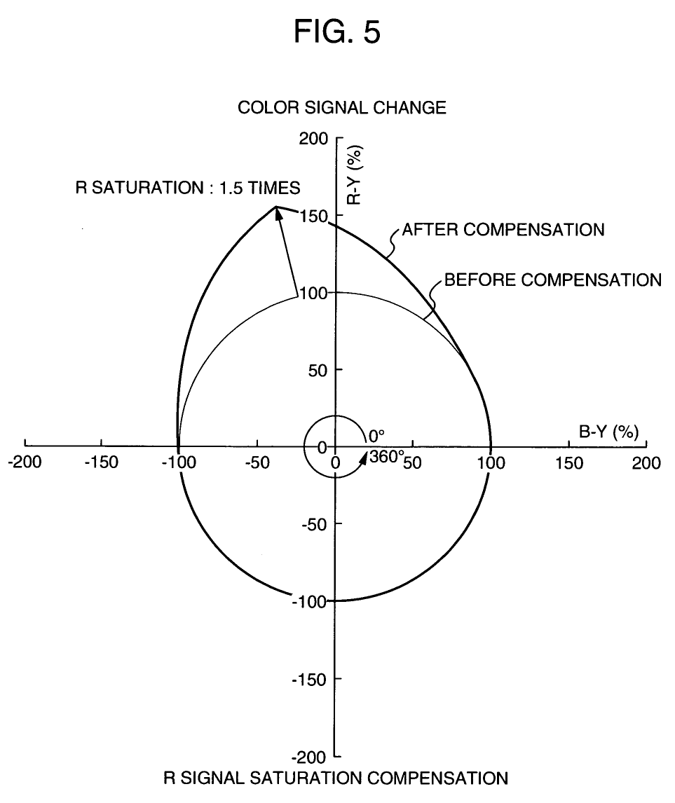

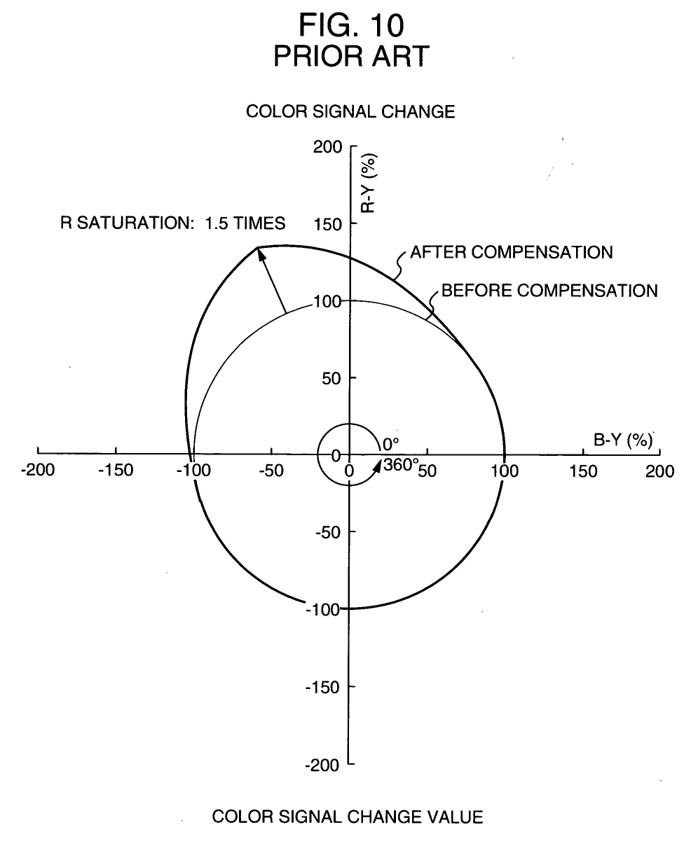

FIG. 5 is a graph showing a saturation level that is 1.5 times that of the R signal obtained by compensation performed in the same manner as that used for the conventional example. When the graph in FIG. 5 is compared with the graph in FIG. 10, which shows the compensation results obtained using the conventional technique, it can be seen that the saturation has been increased and that the hue has been reduced (in the counterclockwise direction). As specific example compensation coefficients used for the case shown in FIG. 5 for providing compatibility with the conventional chroma compensation circuit, Tables 1 and 2 show compensation coefficient values for the increase in the R saturation.

TABLE 1

| | |
|---|---|
| R | saturation compensation coefficient value |

| saturation | Ksr | Ksg | Ksb | Ksc | Ksm | Ksy |
|---|---|---|---|---|---|---|
| 1.0 times | 1.0 | 1.0 | 1.0 | 1.0 | 1.0 | 1.0 |
| 1.2 times | 1.2 | 1.0 | 1.0 | 1.0 | 1.0 | 1.0 |
| 1.5 times | 1.5 | 1.0 | 1.0 | 1.0 | 1.0 | 1.0 |

TABLE 2

| | |
|---|---|
| R | hue compensation coefficient value |

| saturation | Khr | Khg | Khb | Khc | Khm | Khy |
|---|---|---|---|---|---|---|
| 1.0 times | 1.0 | 1.0 | 1.0 | 1.0 | 1.0 | 1.0 |
| 1.2 times | 1.0 | 1.0 | 1.0 | 1.0 | 1.0 | 1.0 |
| 1.5 times | 1.0 | 1.0 | 1.0 | 1.0 | 1.0 | 1.0 |

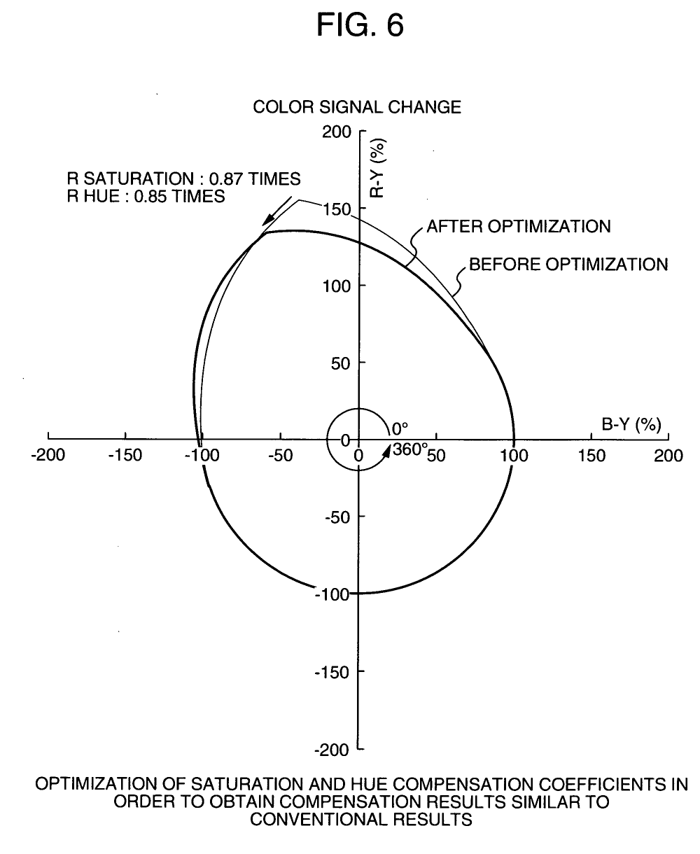

In FIG. 6, a saturation level that is 1.5 times that of the original saturation of the R signal is further multiplied by a coefficient of 0.90 rendering 1.35 times as much, and the hue of the R signal is multiplied by a coefficient of 0.85. In this case, compatibility with the conventional technique can be obtained for the color reproduction shown in FIG. 10. Therefore, compatible color compensation can be performed for television cameras that employ new and those that employ old techniques. Tables 3 and 4 show example numerical values for compensation coefficients in the example in FIG. 6 for maintaining compatibility with conventional compensation results.

TABLE 3

| | |
|---|---|
| R | saturation compensation coefficient value |

| saturation | Ksr | Ksg | Ksb | Ksc | Ksm | Ksy |
|---|---|---|---|---|---|---|
| 1.0 times | 1.0 | 1.0 | 1.0 | 1.0 | 1.0 | 1.0 |
| 1.2 times | 1.14 | 1.0 | 1.0 | 1.0 | 1.0 | 1.0 |
| 1.5 times | 1.35 | 1.0 | 1.0 | 1.0 | 1.0 | 1.0 |

TABLE 4

| | |
|---|---|
| R | hue compensation coefficient value |

| saturation | Khr | Khg | Khb | Khc | Khm | Khy |
|---|---|---|---|---|---|---|
| 1.0 times | 1.0 | 1.0 | 1.0 | 1.0 | 1.0 | 1.0 |
| 1.2 times | 0.95 | 1.0 | 1.0 | 1.0 | 1.0 | 1.0 |
| 1.5 times | 0.85 | 1.0 | 1.0 | 1.0 | 1.0 | 1.0 |

While according to the embodiment, wherein software is used to optimize compensation coefficients, the size of the circuit employed is reduced, the functions provided are the same as those available with the conventional technique. Therefore, according to the embodiment of the present invention, a cost reduction can be realized without an accompanying functional deterioration.

As is described above, according to the embodiment of the invention, since the color compensation operation is performed for the color difference signals, chroma compensation is enabled without the luminance signal being changed.

Furthermore, according to the embodiment, since as in the conventional example the R, G and B signals are employed to detect hues, the use of software is required to optimize the compensation coefficients and to provide the same chroma compensation as is available with the conventional technique.

It should be further understood by those skilled in the art that although the foregoing description has been made on embodiments of the invention, the invention is not limited thereto and various changes and modifications may be made without departing from the spirit of the invention and the scope of the appended claims.

1. A chroma compensation circuit comprising:
a matrix operation unit, to which color signals are applied, for generating a luminance-signal and color difference signals;
a hue area detector for detecting hue areas where said color signals belong;
a hue compensation signal generator for generating a hue compensation signal from said color signals on the bases of said hue area detected by said hue area detector; and
an addition unit for adding said hue compensation signal to said color difference signals in order to compensate hue of said color difference signals.

2. A chroma compensation circuit according to claim 1, wherein said hue compensation signal generator has an hue compensation table which includes information relating to hue compensation of said color difference signals in each hue area.

3. A chroma compensation circuit according to claim 1, further comprises an inverse matrix operation unit, to which said luminance-signal from said matrix operation unit and the hue compensated color difference signals from said addition unit are applied, for generating color signals which hues are compensated.

4. A chroma compensation method comprising the steps of:
generating a luminance-signal and color difference signals from color signals applied to a chroma compensation circuit;
detecting a hue area from said color signals where said color signals belong;
generating a hue compensation signal from said color signals on the bases of said hue area detected; and
adding said hue compensation signal to said color difference signals in order to compensate hue of said color difference signals.

5. A chroma compensation method according to claim 4, wherein said step of generating said hue compensation signal further includes a step of generating information relating to hue compensate of said color difference signals in order to compensate hues of said color difference signal in each hue area.

6. A chroma compensation method according to claim 4, further comprises a step of generating color signals which hues are compensated from said luminance-signal and the hue compensated color difference signals.
